(19) United States
(12) Patent Application Publication
(10) Pub. No.: US 2024/0176349 A1
(43) Pub. Date: May 30, 2024

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: TOSHIYA KOMATA, Kanagawa (JP)

(21) Appl. No.: 18/514,024

(22) Filed: Nov. 20, 2023

(30) Foreign Application Priority Data
Nov. 30, 2022 (JP) 2022-191139

(51) Int. Cl. G05D 1/02

(52) U.S. Cl. CPC G05D 1/0212; G05D 1/0274

(57) ABSTRACT

To perform route setting with a simple operation using an environment map, an information processing device acquires an environment map, acquires a selected point selected as a waypoint of a route on the environment map, and determines route setting coordinate points used for route setting on the basis of a positional relationship between a plurality of coordinate points in the vicinity of the selected point in the environment map.

### BACKGROUND OF THE INVENTION

### Field of the Invention

The present invention relates to an information processing device, an information processing method, a storage medium, and the like for performing route setting.

### Description of the Related Art

For example, there are movable apparatuses such as automated guided vehicles (AGVs) and autonomous mobile robots (AMRs).

In addition, regarding a method for causing such movable apparatuses to autonomously travel within an environment such as a factory or a distribution warehouse, for example, technologies of self-position estimation and environment map creation such as simultaneous localization and mapping (SLAM) and visual SLAM (VSLAM) are used.

In the technology of VSLAM described in Japanese Patent Laid-Open No. 2014-222550, point cloud data is used as an environment map, coordinate points are added to a map to be created in accordance with change in feature points obtained from an image, and continuous coordinate point clouds obtained in such a manner are adopted as a map. A movable apparatus performs self-position estimation using the map generated in that manner, thereby performing automated traveling or autonomous traveling.

An environment map includes many coordinate points thereon, and the larger an environment map becomes, the less likely single points will be able to be visually recognized. For this reason, if route setting for automated traveling is performed by a user operation such as clicking or tapping on an environment map, there is a problem that scale change of the map needs to be repeated until a target point can be visually recognized and thus it is troublesome to perform an operation of route setting.

Although there are technologies, such as a technology described in Japanese Patent Laid-Open No. 2010-198433, in which a target object is selected in accordance with an operation of a user, it is difficult to apply if a target is a point.

### SUMMARY OF THE INVENTION

An information processing device according to one aspect of the present invention has at least one processor or circuit configured to function as: an environment map acquisition unit configured to acquire an environment map; an acquisition unit configured to acquire a selected point selected as a waypoint of a route on the environment map; and a determination unit configured to determine route setting coordinate points used for route setting on the basis of a positional relationship between a plurality of coordinate points in the vicinity of the selected point in the environment map.

Further features of the present invention will become apparent from the following description of embodiments with reference to the attached drawings.

### BRIEF DESCRIPTION OF THE DRAWINGS

FIG. 1 is a view showing a system constitution according to an embodiment of the present invention.

FIG. 2 is a functional block diagram showing a constitution example of an information processing device according to First Embodiment of the present invention.

FIG. 3 is a flowchart showing an example of a processing flow of the information processing device according to First Embodiment.

FIG. 4 is a view showing an example of an environment map.

FIG. 5 is an explanatory view of an example of a user operation.

FIG. 6 is a view showing an example of coordinate points extracted through processing.

FIG. 7 is a view showing processing for each of extracted coordinate points.

FIG. 8 is a view showing an example of line segments using extracted coordinate points.

FIG. 9 is a view showing an example of an environment map according to Second Embodiment.

FIG. 10 is a flowchart showing an example of a processing flow of the information processing device according to Second Embodiment.

FIG. 11 is a view showing an example of coordinate points selected through Steps S1001 to S1005.

FIG. 12 is a view showing an example of a preceding point cloud 1201 and a following point cloud 1202 with respect to a coordinate point 1101 selected through S1005.

FIG. 13 is a view showing an example of approximation straight lines and an intersection thereof.

FIG. 14 is a view showing an example of coordinates selected in Step S1007.

FIG. 15 is a view showing an example of an environment map having a route turning back at a dead end.

FIG. 16 is a flowchart showing an example of a processing flow of the information processing device according to Third Embodiment.

FIG. 17 is a view showing an example of an approximation line calculated from an extracted coordinate point cloud.

FIG. 18 is a block diagram showing a hardware constitution example of the information processing device.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

In the present embodiment, a route setting method for movement control, particularly automated traveling of a movable apparatus such as an automated guided vehicle (AGV) or an autonomous mobile robot (AMR) will be described.

Hereinafter, an AGV will be described as an example of a movable apparatus, but the movable apparatus may be an AMR or a service mobile robot (SMR).

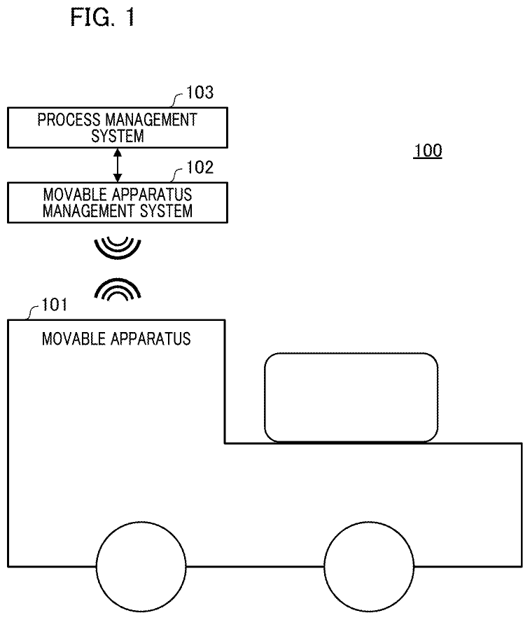

FIG. 1 is a view showing a system constitution according to an embodiment of the present invention. An information management system 100 in the present embodiment is constituted of a plurality of movable apparatuses 101 (101-1, 101-2, and so on), a process management system 103, a movable apparatus management system 102, and the like. The information management system 100 is a distribution system, a production system, or the like.

The plurality of movable apparatuses 101 (101-1, 101-2, and so on) are automated guided vehicles (AGVs) which transport objects in accordance with a schedule of a process determined by the process management system 103. A plurality of movable apparatuses is moving (traveling) within the environment.

The process management system 103 manages processes executed by the information management system 100. For example, it is a manufacturing execution system (MES) which manages processes inside a factory or a distribution warehouse. The process management system 103 communicates with the movable apparatus management system 102.

The movable apparatus management system 102 is a system which manages movable apparatuses and communicates with the process management system 103. In addition, it also communicates with the movable apparatuses 101 (for example, Wi-Fi communication) and interactively transmits and receives operation information.

### First Embodiment

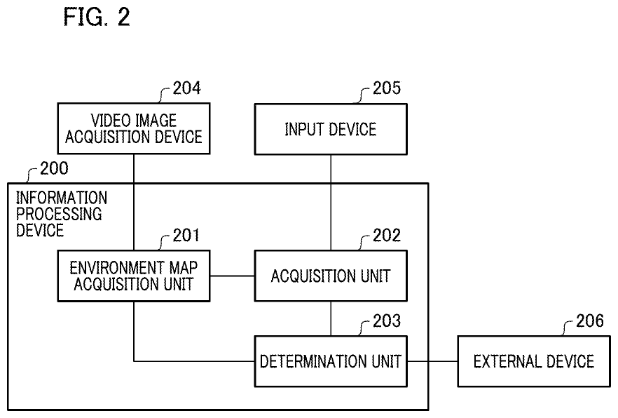

FIG. 2 is a functional block diagram showing a constitution example of an information processing device according to First Embodiment of the present invention. Some of the functional blocks shown in FIG. 2 are realized by causing a CPU or the like serving as a computer included in the information processing device to execute a computer program stored in a memory serving as a storage medium.

However, some or the entirety thereof may be realized by hardware. A dedicated circuit (ASIC), a processor (reconfigurable processor or DSP) or the like can be used as hardware. In addition, the functional blocks shown in FIG. 2 need not be built into the same casing and may be constituted of separate devices connected to each other through signal paths.

An information processing device 200 has an environment map acquisition unit 201 which acquires video images from the outside and creates an environment map, and an acquisition unit 202 which acquires a selected point selected as a waypoint of a route on an environment map. In addition, the information processing device 200 has a determination unit 203 which selects route setting coordinate points used for route setting from an operation performed by a user through route setting.

In addition, a video image acquisition device 204, such as a camera or a PC, having a function of acquiring video images, and an input device 205, such as a mouse or a touch panel, transferring an operation of a user to the information processing device 200 are connected to the information processing device 200. In addition, an external device 206 which displays or receives processing results of the information processing device 200 is connected to the information processing device 200.

However, the constitution in FIG. 2 is an example and is not limited thereto. The information processing device 200 can be mounted in the movable apparatuses 101. In addition, the information processing device 200 can be a device which communicates with the movable apparatuses 101 through Wi-Fi or the like using a network I/F 2303. When the information processing device 200 receives data from the outside, it is physically connected to the outside through a bus or the like or uses the network I/F 2303.

In First Embodiment, when a user selects certain coordinates on an environment map as a waypoint of a route in route setting for automated traveling, a coordinate point desired by the user is determined from a coordinate point cloud in the vicinity of the selected coordinates.

At this time, in First Embodiment, a coordinate point at a position where a movable apparatus needs to make a turn is selected as the coordinate point which is highly likely to be used for route setting for automated traveling. The coordinate points described in the present embodiment correspond to key frames created through SLAM processing.

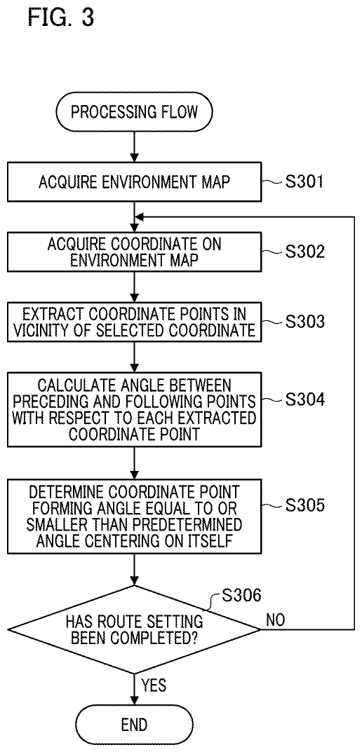

FIG. 3 is a flowchart showing an example of a processing flow of the information processing device according to First Embodiment. When the CPU or the like serving as a computer inside the information processing device 200 executes the computer program stored in the memory, operation of each step of the flowchart in FIG. 3 is performed.

In Step S301, an environment map is acquired. Here, Step S301 functions as an environment map acquisition process of acquiring an environment map. Regarding processing of the information processing device, processing of Step S301 is not essential, and it is also possible to acquire and use a map created by a different device.

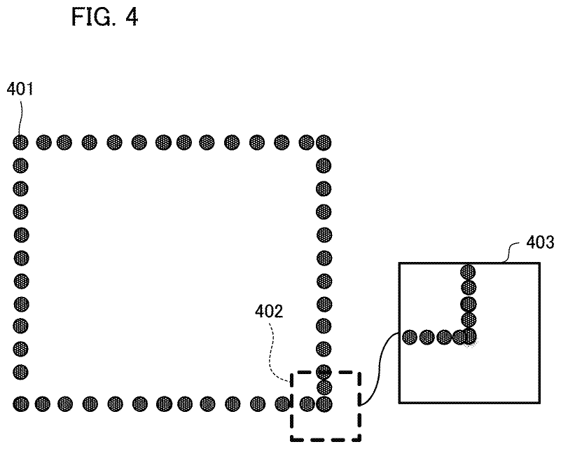

FIG. 4 is a view showing an example of an environment map. FIG. 4 shows a coordinate point 401 which is one of the coordinate point clouds registered through VSLAM processing, a display frame 402 which indicates a region on an environment map, and an enlarged display frame 403 which displays the display frame 402 in an enlarged manner. An environment map is shown in point clouds, but an environment map can also be shown in a line by connecting these point clouds with a line. The same can be said for everything after FIG. 4.

Coordinate points registered in an environment map include information of positions, for example, (x, y, z) on the environment map. In addition, posture information indicating a posture such as a direction of a movable apparatus may be included. In this manner, an environment map may be constituted of point clouds having a plurality of dense coordinate points.

In the present embodiment, an environment map is created through VSLAM. However, as shown in FIG. 4, an environment map may be created by any method as long as the method can express it in point clouds. In addition, an environment map which has already been created may be downloaded from a server or the like.

In Step S302, a coordinate on an environment map is acquired and designated by an operation of a user. Step S302 functions as an acquisition process of acquiring a selected point selected as a waypoint of a route on an environment map. A user performs a touch-operation with respect to the touch panel of the input device 205 or the external device 206, for example. A mouse-operation can also be performed while viewing a monitor of the input device 205 or an external device.

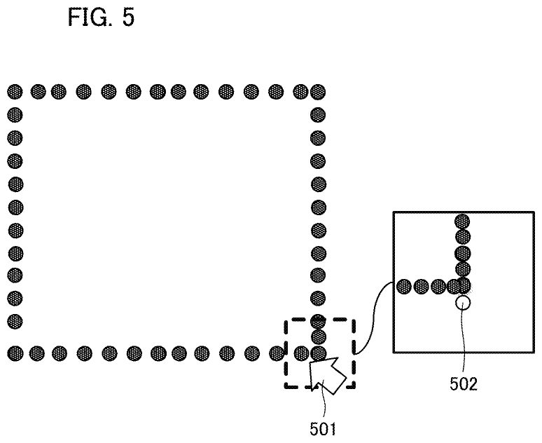

FIG. 5 is an explanatory view of an example of a user operation. In FIG. 5, a selected point 502 selected by a mouse cursor 501 and a mouse click is indicated on an environment map. In this manner, it is assumed that a user selects a point near a target coordinate point.

Here, a mouse click is presented as a user operation, but it is not limited thereto. For example, an operation in which one point is selected by tapping a screen or the like may be adopted.

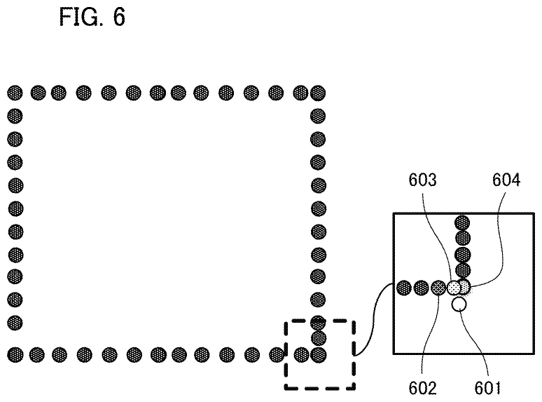

In Step S303, as candidates for waypoints used for route setting, coordinate points in the vicinity of the selected point selected by a user operation are extracted. Distances between a selected point and coordinate points are utilized for extraction, and three points are extracted in order of points having a shorter distance. FIG. 6 is a view showing an example of coordinate points extracted through processing. FIG. 6 shows a selected point 601 and extracted coordinate points 602, 603, and 604.

In this manner, in the present embodiment, a plurality of coordinate points corresponding to the point selected by a user are extracted as candidates for the waypoints for route setting. An example in which distances between a selected point and coordinate points are used for extraction of candidate points has been described, but the extraction method is not limited as long as coordinate points in the vicinity of a selected point can be extracted. For example, all the coordinate points within a frame may be extracted as candidates by setting the frame near a selected point.

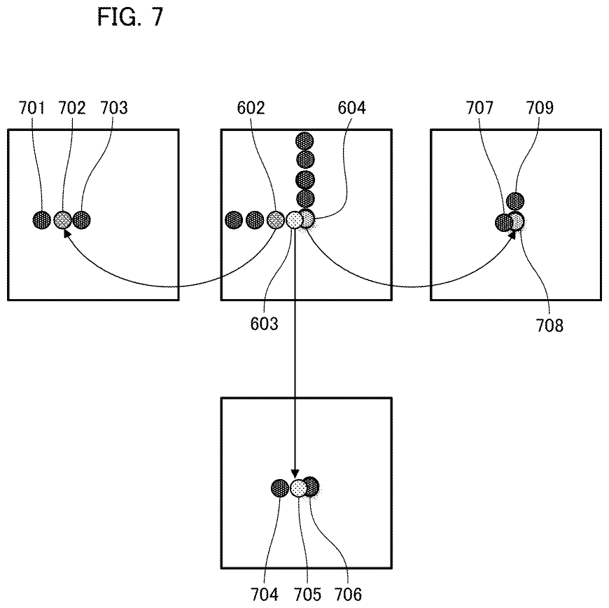

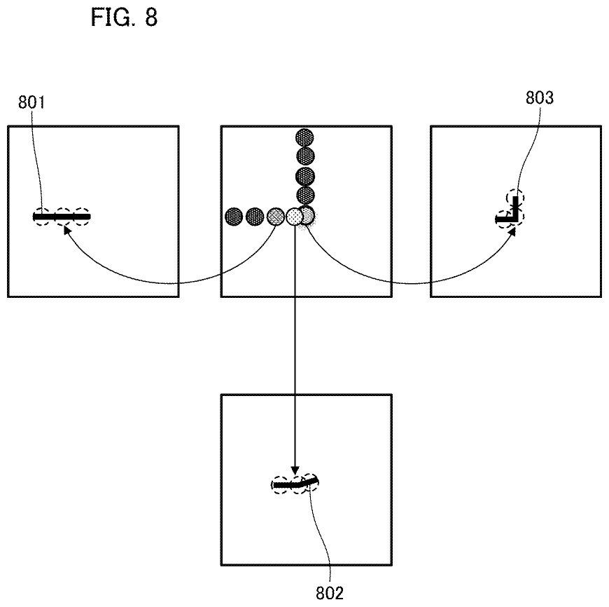

In Step S304, for each of the coordinate points extracted as the candidates for coordinate points used as waypoints for route setting, the angles formed by the coordinate point and the preceding and following points are calculated. This will be described using FIGS. 7 and 8. FIG. 7 is a view showing processing for each of the extracted coordinate points.

In FIG. 7, points 701, 702, and 703 indicate the extracted coordinate point 602 and the preceding and following coordinate points thereof. The coordinate point 702 corresponds to the coordinate point 602. Points 704, 705, and 706 indicate the extracted coordinate point 603 and the preceding and following coordinate points thereof. The coordinate point 705 corresponds to the coordinate point 603. Points 707, 708, and 709 indicate the extracted coordinate point 604 and the preceding and following coordinate points thereof. The coordinate point 708 corresponds to the coordinate point 604.

Since point clouds of an environment map have continuity, it is utilized. In this description, preceding and following coordinate points are simply used, but the interval between the coordinates used may be able to be arbitrarily changed. For example, coordinate points skipping one or two therebetween may be used. In addition, it is not necessary to use three coordinate points, and more coordinate points, such as five, may be used.

FIG. 8 is a view showing an example of line segments using extracted coordinate points. FIG. 8 shows line segments in which the coordinate points are connected. In addition, in FIG. 8, a line segment 801 is a line segment constituted of a line segment connecting the coordinate point 701 and the coordinate point 702 and a line segment connecting the coordinate point 702 and the coordinate point 703.

In addition, a line segment 802 is a line segment constituted of a line segment connecting the coordinate point 704 and the coordinate point 705 and a line segment connecting the coordinate point 705 and the coordinate point 706. In addition, line segment 803 is a line segment constituted of a line segment connecting the coordinate point 707 and the coordinate point 708 and a line segment connecting the coordinate point 708 and the coordinate point 709.

In Step S304, the angles formed by the line segments created in this manner are individually calculated. The angles are calculated using, for example, a generally used relational expression for inner product of vectors or the like. For example, it is calculated that the line segment 801 forms an angle of 180 degrees, the line segment 802 forms an angle of 145 degrees, and the line segment 803 forms an angle of 90 degrees.

In Step S305, a coordinate point to be used for route setting is selected from the values of the angles obtained in Step S304. In FIG. 8, it can be judged that the line segments 801 and 802 have small angles and are close to straight lines while the line segment 803 has an angle equal to or smaller (approximately 90 degrees) than a predetermined angle (for example, 120 degrees).

For this reason, the coordinate point 603 at the center of three coordinate points forming the line segment 803 is selected as the coordinate point having a high probability of being used for route setting. This is because it is important for a waypoint for route setting to be often a so-called corner and it can be estimated that a user who has selected the selected point 502 intends to select a point corresponding to a corner.

In the example in FIG. 8, a point forming an angle of 90 degrees is selected. However, in Step S305, a coordinate point forming an angle equal to or smaller than a predetermined angle centering on the coordinate itself may be selected.

The foregoing predetermined angle may be an angle set in advance. For example, as described above, 120 degrees or the like may be set as the predetermined angle. Here, Step S303 to Step S305 function as determination processes of determining route setting coordinate points used for route setting on the basis of the positional relationship between a plurality of coordinate points in the vicinity of the selected point in the environment map.

In Step S306, it is judged whether route setting is completed. If it is judged that it has been completed, route setting is confirmed, and if it has not ended, the process returns to Step S302 and a next coordinate point is selected. In Step S305, instead of selecting a coordinate point forming an angle equal to or smaller than the foregoing predetermined angle, a coordinate point having the smallest angle centering on itself may be selected from a plurality of angles calculated in Step S304.

In this manner, in First Embodiment, the determination unit 203 determines route setting coordinate points on the basis of the angles formed by a plurality of coordinate points. Therefore, even if an environment map is large and a target coordinate point is in a state of being unlikely to be visually recognized, a user can select a coordinate point suitable for route setting by a simple operation and suitable route setting can be performed smoothly.

### Second Embodiment

In First Embodiment, an example in which a spot where a movable apparatus makes a turn, that is, a coordinate point where a line segment connecting continuous coordinate points forms an angle equal to or smaller than a predetermined angle is selected as a coordinate point to be used as a waypoint of a route has been described. However, an environment map is not limited to being constituted of only curves.

For example, an environment map including a T-shape or a cross can be considered. In such a case, a point closer to a junction of the T-shape or the cross becomes the coordinate point suitable for route setting. For this reason, in Second Embodiment, a coordinate point close to such a junction is selected.

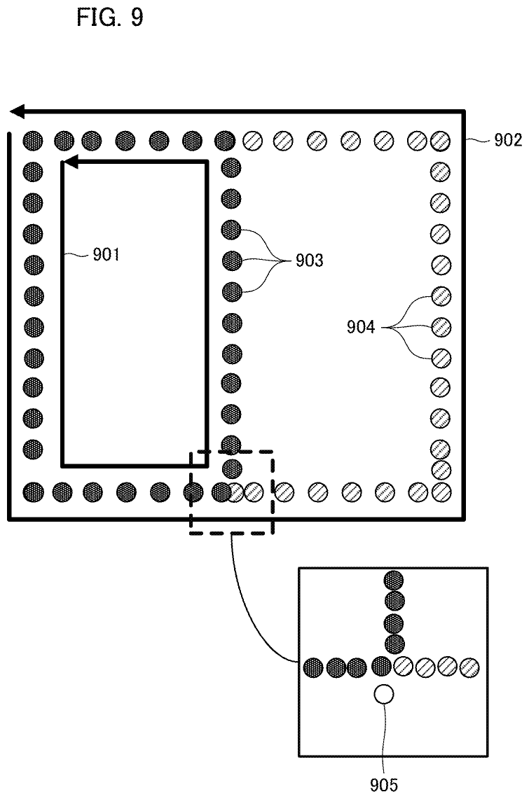

FIG. 9 is a view showing an example of an environment map according to Second Embodiment. In FIG. 9, routes 901 and 902 show a situation in which an environment map indicated by points is generated as a result of movement of a movable apparatus having a stereo camera, a depth camera, or the like mounted therein and measurement of an environment using sensor data.

An example having the routes 901 and 902 used for creation of an environment map, a coordinate point cloud 903 and a coordinate point cloud 904 on the registered environment map, and a selected point 905 selected by a user is shown. Here, coordinate points registered through creation of the environment map of the route 901 will be regarded as the coordinate point cloud 903, and a coordinate point cloud registered through creation of the environment map of the route 902 will be regarded as 904.

Similar to First Embodiment, an environment map can be created by a different information processing device, and it can be acquired and utilized. Hereinafter, the same applies to other embodiments.

Although expression on an image is simplified for easy description, it is assumed that the coordinate points which belong to the coordinate point cloud 903 and the coordinate points which belong to the coordinate point cloud 904 are separately registered at overlapping spots on the route in the route 901 and the route 902. That is, additional coordinate points can also be registered at positions in the vicinity of the place where a coordinate point is already present on the environment map.

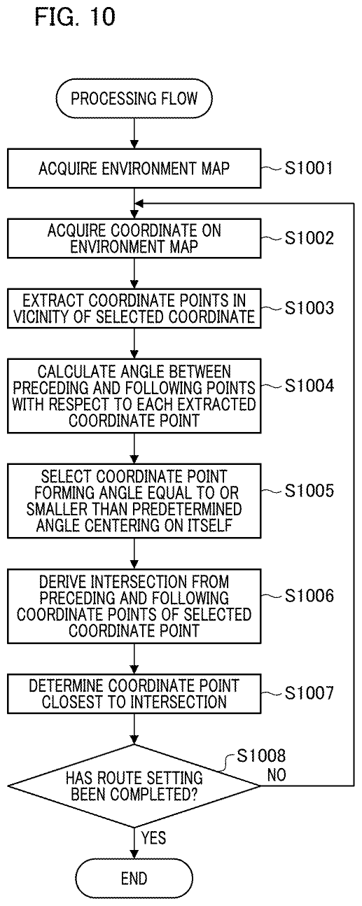

FIG. 10 is a flowchart showing an example of a processing flow of the information processing device according to Second Embodiment. When the CPU or the like serving as a computer inside the information processing device 200 executes the computer program stored in the memory, operation of each step of the flowchart in FIG. 10 is performed.

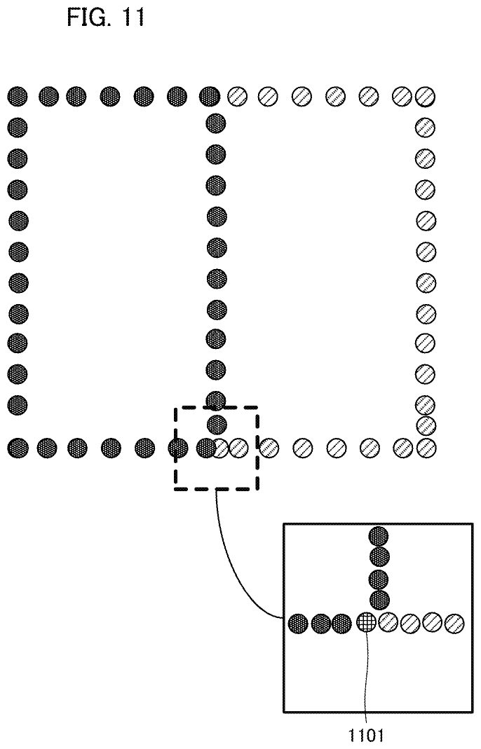

Since the processing of Steps $1001 to S1005 in FIG. 10 is similar to the processing of S301 to S305 in FIG. 3 described in First Embodiment, description thereof will be omitted. In Steps S1001 to S1005, a coordinate point 1101 is selected as shown in FIG. 11 by performing processing similar that of S301 to S305.

FIG. 11 is a view showing an example of coordinate points selected through Steps S1001 to S1005. Step S1005 indicates a state in which the coordinate point 1101 forming an angle equal to or smaller than a predetermined angle centering on itself is selected.

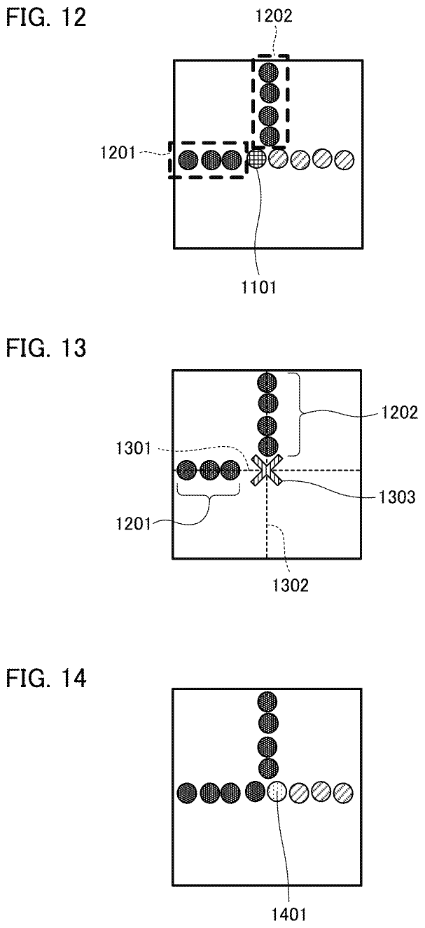

In the present embodiment, subsequently, in Step S1006, an approximation straight line is obtained with respect to each of the preceding and following point clouds of the selected coordinate point 1101, and the intersection thereof is derived. FIG. 12 is a view showing an example of a preceding point cloud 1201 and a following point cloud 1202 with respect to the coordinate point 1101 selected through S1005.

Moreover, in Step S1006, an approximation straight line is obtained with respect to each of the point cloud 1201 and the point cloud 1202. FIG. 13 is a view showing an example of approximation straight lines and an intersection thereof and shows an example of an approximation straight line 1301 obtained from the point cloud 1201, an approximation straight line 1302 obtained from the point cloud 1202, and an intersection 1303 of these approximation straight lines.

In Step S1007, a coordinate point closest to the derived intersection 1303 is determined. FIG. 14 is a view showing an example of coordinates selected in Step S1007. In FIG. 14, a coordinate point 1401 is determined as the coordinate point closest to the intersection 1303.

As described above, in Second Embodiment, the determination unit 203 determines, as a route setting coordinate point, the coordinate point on the environment map at a position closest to the intersection of a plurality of approximation lines calculated on the basis of a plurality of coordinate points. Therefore, in a complicated environment map including a shape such as a T-shape or a cross, a user can select a coordinate point suitable for route setting by a simple operation.

### Third Embodiment

The shape of an environment map may include not only a simple circular route but also a route turning back at a dead end. In that case, the coordinate point at the farthest part of the dead end may be used for route setting. In Third Embodiment, an example in which such a coordinate point at the farthest end is selected will be described.

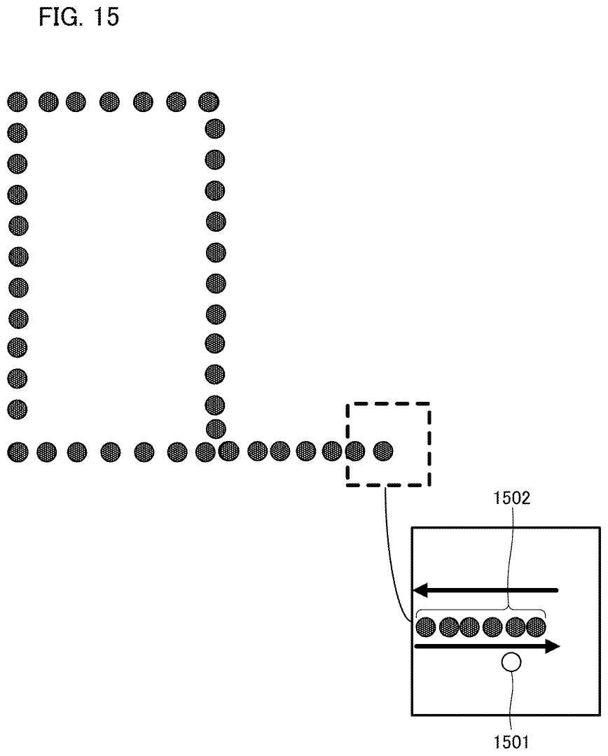

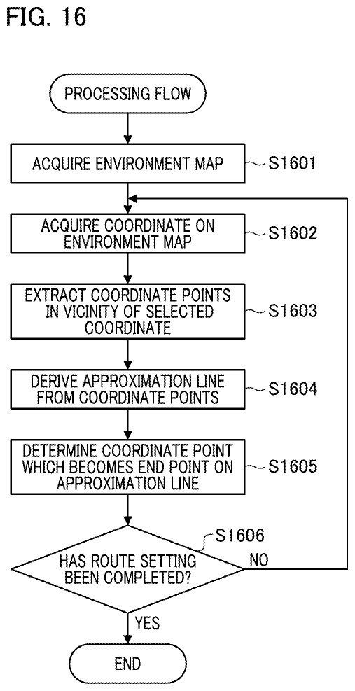

FIG. 15 is a view showing an example of an environment map having a route turning back at a dead end. In addition, FIG. 16 is a flowchart showing an example of a processing flow of the information processing device according to Third Embodiment. When the CPU or the like serving as a computer inside the information processing device 200 executes the computer program stored in the memory, operation of each step of the flowchart in FIG. 16 is performed.

Since the processing of Step S1601 to Step S1603 is similar to the processing of S301 to S303 in FIG. 3 described in First Embodiment, description thereof will be omitted. In Steps S1601 to S1603, a coordinate point cloud 1502 in the vicinity of a coordinate 1501 selected as shown in FIG. 15 is extracted by performing processing similar that of S301 to S303.

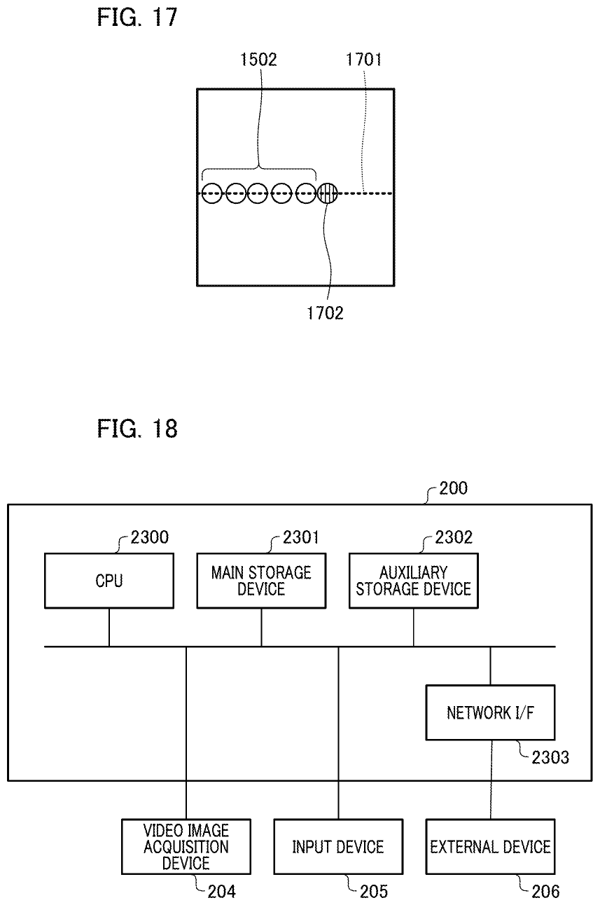

In Step S1604, an approximation line is obtained from the extracted coordinate point cloud. FIG. 17 is a view showing an example of an approximation line calculated from an extracted coordinate point cloud. As shown in FIG. 17, in Step S1604, an approximation line 1701 is calculated from the extracted coordinate point cloud 1502.

In Step S1605, a coordinate point which becomes an end point on the approximation line is selected. That is, as shown in FIG. 17, a coordinate point 1702 at the farthest end is determined as a coordinate point to be used for route setting from the coordinate points in the vicinity of the approximation line 1701.

As described above, in Third Embodiment, the determination unit 203 determines a coordinate point positioned at the farthest end as a route setting coordinate point from a plurality of coordinate points in the vicinity of the approximation line on the environment map. Therefore, even in a complicated environment map including a route turning back at a dead end, a user can select a coordinate point suitable for route setting by a simple operation.

Moreover, by combining First to Third Embodiments, even in a corner shown in FIG. 8, in a T-shape or a cross shown in FIG. 14, and at a dead end shown in FIG. 17, a user can select a coordinate point suitable for route setting by a simple operation.

FIG. 18 is a block diagram showing a hardware constitution example of the information processing device. As shown in FIG. 18, the information processing device 200 includes a CPU 2300, a main storage device 2301, an auxiliary storage device 2302, and the network I/F 2303. In addition, the video image acquisition device 204 and the input device 205 are connected, for example, to a bus of the information processing device.

The CPU 2300 of the information processing device 200 executes processing using a computer program or data stored in a main storage device 212. Accordingly, the CPU 2300 controls operation of the information processing device 200 in its entirety and executes or controls each process of the processing described above executed by the information processing device.

For example, the CPU 2300 realizes operation of the flowcharts shown in FIGS. 3, 10, and 16 by executing processing using the computer program or data stored in the main storage device 2301.

The main storage device 2301 is a storage device such as a random access memory (RAM). The main storage device 2301 stores a computer program or data loaded from the auxiliary storage device 2302. In addition, it has an area for storing captured images acquired by the video image acquisition device 204, and various kinds of data received from the external device 206 through the network I/F 2303.

Moreover, the main storage device 2301 has a work area used when the CPU 2300 executes various kinds of processing. In this manner, the main storage device 2301 can appropriately provide various kinds of areas.

The auxiliary storage device 2302 is a large-capacity information storage device such as a hard disk drive (HDD), a read only memory (ROM), or a solid state drive (SSD).

In the auxiliary storage device 2302, a computer program or data for causing the CPU 2300 to execute or control an operating system (OS), or each process of the processing described above to be performed by the information processing device is saved. In addition, in the auxiliary storage device 2302, data (for example, the foregoing image-capturing parameters) received from the external device 206 through the network I/F 2303 is also saved.

The computer program or data saved in the auxiliary storage device 2302 is appropriately loaded to the main storage device 2301 in accordance with control of the CPU 2300 and becomes a processing target of the CPU 2300. The network I/F 2303 is an interface utilized for performing data communication between the information processing device 200 and the external device 206 through a network.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device through a network or various storage media. Then, a computer (or a CPU, an MPU, or the like) of the information processing device may be configured to read and execute the program. In such a case, the program and the storage medium storing the program configure the present invention.

In addition, the present invention includes those realized using at least one processor or circuit configured to function of the embodiments explained above, for example. Dispersion processing may be performed using a plurality of processors.

This application claims the benefit of Japanese Patent Application No. 2022-191139, filed on Nov. 30, 2022, which is hereby incorporated by reference herein in its entirety.

What is claimed is:

1. An information processing device comprising:
at least one processor or circuit configured to function as:
an environment map acquisition unit configured to acquire an environment map;
an acquisition unit configured to acquire a selected point selected as a waypoint of a route on the environment map; and
a determination unit configured to determine route setting coordinate points used for route setting on the basis of a positional relationship between a plurality of coordinate points in the vicinity of the selected point in the environment map.

2. The information processing device according to claim 1,
wherein the determination unit determines the route setting coordinate points on the basis of angles formed by the plurality of coordinate points.

3. The information processing device according to claim 1,
wherein the determination unit determines, as the route setting coordinate points, coordinate points on the environment map at a position closest to an intersection of a plurality of approximation lines calculated on the basis of the plurality of coordinate points.

4. The information processing device according to claim 1,
wherein the determination unit determines, as the route setting coordinate points, coordinate points positioned at a farthest end from the plurality of coordinate points on the environment map in the vicinity of an approximation line calculated on the basis of the plurality of coordinate points.

5. An information processing method comprising:
acquiring an environment map;
acquiring a selected point selected as a waypoint of a route on the environment map; and
determining route setting coordinate points used for route setting on the basis of a positional relationship between a plurality of coordinate points in the vicinity of the selected point in the environment map.

6. A non-transitory computer-readable storage medium configured to store a computer program comprising instructions for executing following processes:
acquiring an environment map;
acquiring a selected point selected as a waypoint of a route on the environment map; and
determining of determining route setting coordinate points used for route setting on the basis of a positional relationship between a plurality of coordinate points in the vicinity of the selected point in the environment map.
